(19) United States
(12) Patent Application Publication
(10) Pub. No.: US 2007/0047395 A1
(43) Pub. Date: Mar. 1, 2007

(54) Optical disk shred operation with detection

(75) Inventors: Bruce J. Skeeter, Colorado Springs, CO (US); Brian L. Worby, Colorado Springs, CO (US); Keith R. Holstine, Colorado Springs, CO (US); David A. Bolt, Colorado Springs, CO (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Plasmon LMS, Inc., Colorado Springs, CO (US)

(21) Appl. No.: 11/510,168

(22) Filed: Aug. 25, 2006

Related U.S. Application Data
(60) Provisional application No. 60/711,471, filed on Aug. 26, 2005.

(51) Int. Cl. G11B 21/08

(52) U.S. Cl. 369/30.04

(57) ABSTRACT

Data protection and security is provided by incorporating a data shredding operation which renders data previously stored on storage media unrecoverable. In the shredding operation of the present invention, certain overhead portions of a data storage sector remain unchanged, while the data area is overwritten with a predetermined pattern. By maintaining the overhead portions of the sectors (addressing, verify and protect, error correction codes, etc.) the sectors can be easily identified as being previously shredded, thus not providing a source of possible confusion to the data storage device. Further, the data becomes unrecoverable as it has been overwritten by the predetermined pattern, which thus eliminates all previously existing transitions which contained the encoded data.

### CROSS REFERENCE TO RELATED APPLICATIONS

This application claims the benefit of U.S. Provisional Application No. 60/711,471, filed Aug. 26, 2005.

### BACKGROUND OF THE INVENTION

The present invention is directed toward a method and system to accomplish an optical disk shred operation. More specifically the method and system provides the ability for data in an optical disk sector to be shredded (destroyed) so the data is no longer recognizable. Further, the method and system allows for the identification of an intentionally destroyed area as a shredded sector when the storage system attempts to read the sector.

Data security and data privacy are continuing issues in the world today. Naturally, those in the data storage industry are challenged to provide their assistance in dealing with these issues. In many situations, data storage providers receive requests from users to provide solutions which help to protect the integrity of information stored in various systems, and tools to prevent the undesired access to data. In one more specific situation, users ask for the tools to appropriately destroy or permanently eliminate data from storage media. In the optical media storage industry, no solution presently exists to insure this data destruction is accomplished. The ability to shred data is becoming a requirement for storage devices to meet various industry regulations relating to data retention periods. Efficiently providing this capability is thus very important.

In the hard disk industry, the approach to data destruction is the use of multi-pass erase or overwrite operations, rewriting a specific set of patterns as many a ten times. As might be anticipated, this multi-pass overwrite operation can be very time consuming. Further, if this technique is not used, the data (documents or files) may still be present on the disk creating a possibility that the data can be recovered, thus presenting a potential liability risk for business processes. In addition, there is no indication that the data has been destroyed, which may create problems during subsequent operation.

The objectives of the erase or destroy operations are to ensure that the information on the media is not recoverable. Magnetic disk erase operations may leave physical traces of recorded data that can be recovered using special procedures. This is obviously undesirable when the specific goal is to completely erase or destroy the data. To avoid data recovery on magnetic disks, a multi-pass erase and overwrite operation can be employed. This is obviously the tactic used in the hard disk example referenced above. Again, this multi-pass overwrite operation can be very time consuming and is thus undesirable.

### BRIEF SUMMARY OF THE INVENTION

Generally speaking, the present invention provides a data shred operation to an optical storage media by overwriting the data portion of a relevant data sector with a continuous series of predetermined characters. Any addressing and synchronization information for that particular sector is left alone, thus allowing for sector location and addressing. Overwriting only the data portion of the sector allows for easy identification as a “shredded” sector, which provides several advantages. Further, optical data destruction of the present invention uses a secure two-pass shred operation. The first pass is for the destruction of the data and the second pass is to verify that the operation was successfully completed.

As is understood by those skilled in the art, data is typically stored on storage media in a sector format. Each sector includes a number of defined areas, with each area designated for a specific function or feature. Naturally, each sector contains a large portion which is designated for user data storage. Other areas of the sector may include addressing portions, error correction code portions, synchronization portions, verification portions, and other overhead functions. Naturally, each of theses designated areas coordinate with system operations to achieve efficient operation of the storage system.

As mentioned above, an objective of the present invention is to insure that data stored on the storage media is no longer decipherable by subsequent operations. Consequently, the primary focus of the present invention is on the data storage areas within each data sector. As such, the data shred operation of the present invention carries out steps to overwrite the data storage area without disturbing information stored in other areas of the data sector. By destroying or shredding data in this manner, the data storage system can easily recognize the shredded sectors during subsequent operations, thus insuring proper operation in the future.

In the actual process carried out by the data storage system to shred data, the desired data storage sector is first identified and located. Naturally, this identification will be based upon requests from the related systems cooperating with the data storage system. Once identified and located, the data storage area within the identified sector is over-written with a predetermined pattern of marks and spaces. In one embodiment, this includes a continuous series of spaces. Other areas within the data sector are left unchanged, thus being easily identifiable by the data storage system. Following the over-writing step, the data storage system will perform a verify step wherein the information in the identified sector is read to confirm that desired modifications have been made. Further attempts by the data storage system to read this sector will correctly identify this sector as a shredded sector.

As suggested above, it is an object of the present invention to provide a process for the destruction of information stored within a data storage system. In one embodiment, it is an object to destroy information contained on an optical storage media.

It is a further object of the present invention to provide a data shredding operation which is efficient and effective. The efficiency of such an operation is dependent upon the speed at which the operation can be carried out, along with the effectiveness. Consequently, the desired process should be very quickly carried out to destroy data so that is no longer decipherable.

It is another object of the present invention to provide a data shredding operation which will not create further confusion for the data storage system. Hence, it is necessary to destroy or shred data in such a manner so that it can subsequently be identified as shredded data. Consequently, the data storage system will be able to deal with this shredded information in a reasonable and logical manner.

### BRIEF DESCRIPTION OF THE DRAWINGS

Further objects and advantages of the present invention can be seen from reading the following detailed description and reviewing the drawings in which:

FIG. 1 is a representative data storage system incorporating the methodology of the present invention;

FIG. 2 is a schematic representative of a written data sector;

FIG. 3 is a schematic representation of a data sector after the shred operation has been carried out;

FIG. 4 is a flowchart outlining the shred process;

FIG. 5 is a graphic illustration of the media surface showing the beginning portions of various data sectors having written and shredded data stored therein; and

FIG. 6 is a graphic illustration of the media surface showing an end portion of various data sectors having shredded portions.

### DETAILED DESCRIPTION OF THE INVENTION

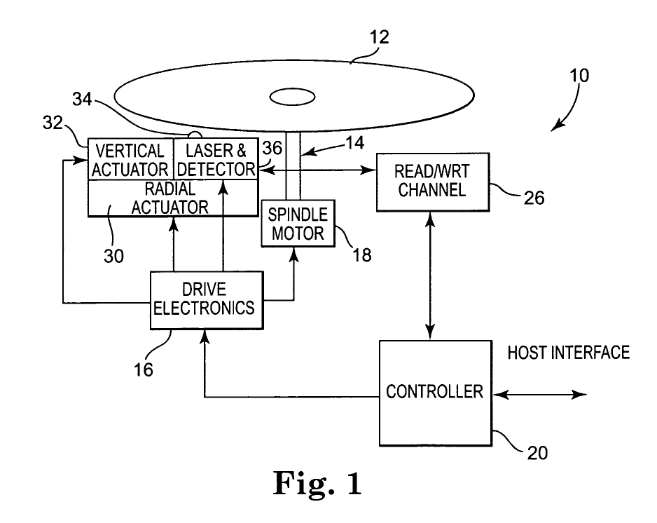

Again, the present invention relates to a data shredding methodology used within a data storage device. While the data storage device can take many forms, one exemplary system is shown in FIG. 1. Data storage device 10 utilizes a storage media 12, which in the preferred embodiment is an optical storage device. The use of optical storage media 12 has become well known and widely used in the industry because of its data storage capabilities and ease of access to data. In the present invention, the data storage media 12 is preferably removable, however could also be fixed within storage system 10. Storage media 12 is operably attached via a drive shaft 14 to a spindle motor 18. The drive shaft 14 is driven by spindle motor 18 which is controlled by drive electronics 16. Cooperating with drive electronics 16 are a laser assembly 36 including the laser itself (not shown), optics (not shown), and detection circuitry (not shown). Attached to laser assembly 36 are a radial actuator 30 and a vertical actuator 32 to provide appropriate movement and positioning. A lens 34 focuses a laser beam toward the desired region on media 12.

Laser assembly 36 is also connected to a read/write channel 26 for transferring the appropriate signals to and from the media 12. Similarly, read/write channel 26 is attached to controller 20 which coordinates the overall operation of storage device 10. Laser assembly 36 includes a typical split detector (not shown) used for tracking on media 12. As further outlined below, this split detector provides signals indicative of the structures present on the surface of media 12, including addressing information signals, data signals, and synchronization signals.

As illustrated in FIG. 1 and briefly discussed above, read/write channel 26 is utilized to receive output signals from the detector and thus provide appropriate signals to external devices. The controller 20 coordinates with the read/write channel 26 to achieve data shredding capabilities. As understood by those skilled in the art, the configuration of the drive itself may vary, including additional components, or involved coordination with an external system.

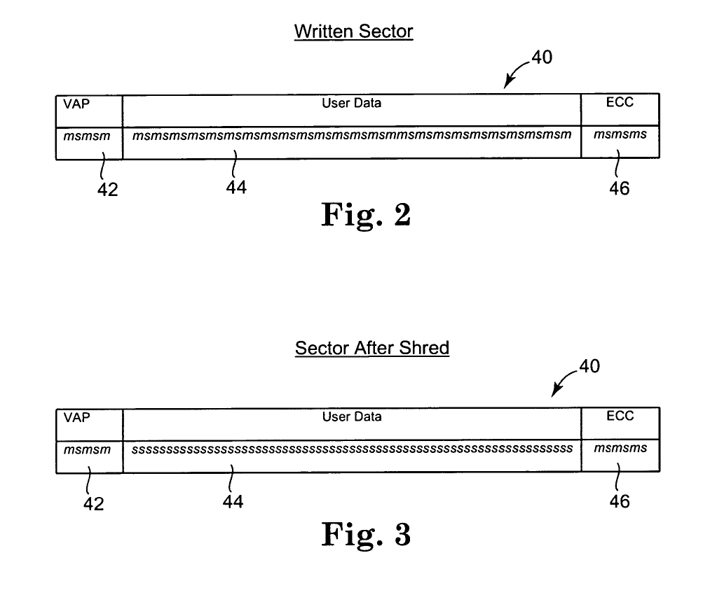

As suggested above, the shred operation of the present invention works at the sector level. Referring to FIG. 2, a data sector 40 is illustrated in schematic form. Generally, data sector 40 on the optical storage media can be broken up into at least three basic fields, the VAP (Verify And Protect) field 42, the user data field 44 and the ECC (Error Correction Code) field 46. Each of these fields is also schematically illustrated and appropriately labeled in FIG. 2. When information is written, all three fields will contain various combinations of marks (m) and spaces (s).

The VAP field 42 is very small, using less than one tenth of one percent of the sector. VAP field 42 provides a means to quickly detect an attempted overwrite of a sector and to insure that data is not inadvertently overwritten. In summary, this field provides a quick indication of the sector's status at an initial portion of the sector.

Data field 44 contains user data and uses about 90% of the total sector size. As is well known, data field 44 will contain a series of marks and spaces which makes up encoded data stored in this area. This data may be stored or encoded in any number of possible ways. For example, data may be stored using the well known 1,7 RLL data encoding scheme.

The data field 44 is followed by ECC field 46, which makes up the remaining 10% (approximately) of the sector. ECC field 46 contains coded parity information about the data in the sector that allows the drive to reconstruct the data field if parts of the data field 44 are unreadable. Naturally, alternative data structures or fields may also exist. The shred operations of the present invention would be compatible with virtually any sector configuration that has an isolated data storage area. Further, the fields discussed above may also have additional features.

Again, the protection of information is a concern for many different organizations. To provide additional data protection tools, the present invention provides a shred operation that removes existing data and provides mechanisms to insure that the data cannot be recovered. The shred operation works by writing a continuous pattern of spaces over the entire data field 44 while leaving the VAP field 42 and ECC field 46 intact. Writing a continuous space pattern, represented by “s” in FIG. 3, eliminates all of the transitions that existed within data field 44. In optical storage systems, these transitions contain all relevant information, thus their elimination removes data contained in those sections. Once the shred operation has been completed the sector may be read back to verify that transitions exist in the VAP field 42 and ECC field 46 while no transitions exist in the data field 44.

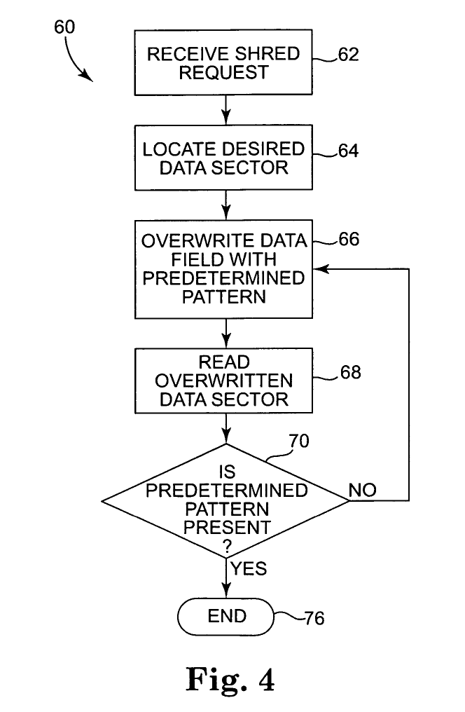

Referring now to FIG. 4, there is shown a flow chart outlining the steps for shredding data as contemplated by the present invention. The data shred process 60 begins by receiving a shred request 62 from an external system. For example, a related computer system, or storage module may communicate with the data storage system requesting that certain portions of data be shredded. Naturally, the format of this request and the details can vary greatly, however the concept is fairly well understood by those skilled in the art. Next, at step 64 the desired data sector is located. This will be carried out utilizing well known and understood addressing techniques. Once the desired sector is located, the present process carries out step 66 which overwrites the data field within the desired sector with the predetermined pattern. As mentioned above, the preferred embodiment utilizes a continuous series of spaces across the entire data sector. Following this overwrite step, the process moves to step 68 where the overwritten data sector is read back to confirm the overwrite operation was successful. As seen in step 70, the system evaluates the success of the overwrite process. If the desired predetermined pattern does not exist in the relevant data sector, the process will loop back to step 66 and carry out the overwrite step once again. However, if step 70 determines that the overwritten sector has been successfully written with the predetermined pattern, the process simply moves to the END 76 and the shredding of that particular sector is completed.

While the above-referenced discussion provides the steps related to the shredding of a particular data sector, it is clearly understood, that this same process could be modified to process a number of sectors consecutively or in a batch manner. Further, the verify operation could likewise could be carried out on a group or batch basis.

Shredding the sector in the manner described above allows for the subsequent detection of a shredded sector while also maintaining general operating capabilities. If all fields within the sector were destroyed, the drive could confuse the sector(s) as unwritten or damaged causing unnecessary read retry operations. This would degrade performance while still leaving the question as to whether the sector had been shredded, or if it was just unrecoverable. When the sector is read, in a standard method, it will result in an uncorrectable status. Once the sector is uncorrectable, a check is made to determine if the VAP and ECC regions exist while the user data area contains all spaces (or the predetermined pattern). If this condition exists, then the sector is considered shredded and notification is given.

Allowing for the subsequent detection of shredded sectors as outlined above, provides certain advantages. Identifying shredded sectors allows the system to differentiate between an unreadable sector and a sector that has been purposely shredded. In addition, since no data marks are written in the sectors of the preferred embodiment, it will be easier to implementation for backward compatibility with future optical drives since it is easier to write and detect all spaces than precise marks and spaces.

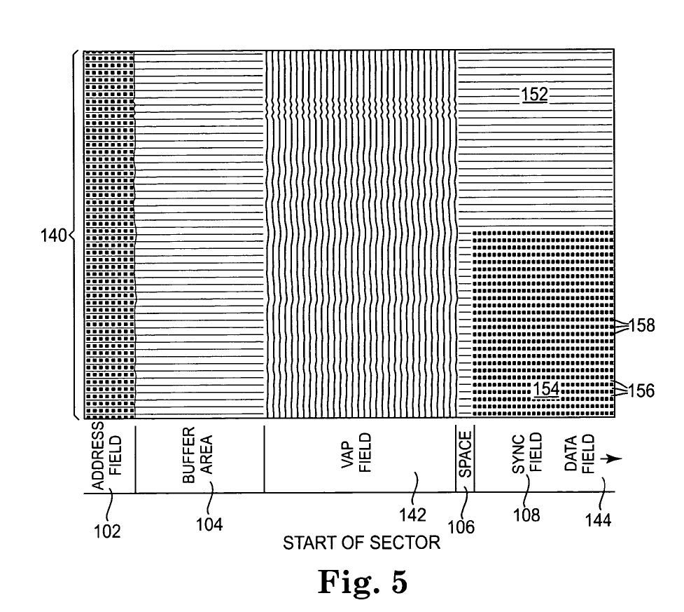

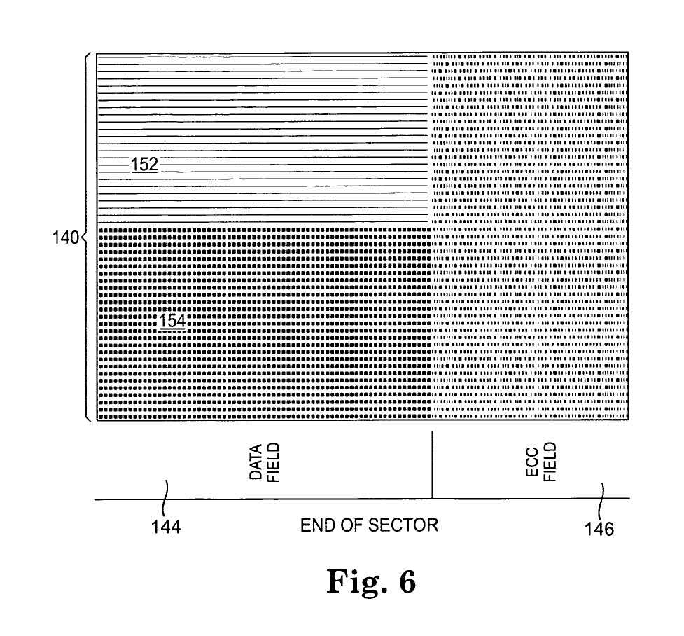

FIGS. 5 and 6 are graphical illustrations of different sections on a disk showing a typical collection of data sectors. These figures show the differences between the various structures on the surface of the disk. As can be appreciated, these structures can be easily differentiated. More specifically, FIG. 5 illustrates the initial portions of several parallel data sectors 140. In this particular figure, data sectors 140 are arranged horizontally, and each start with an address field 102. Immediately adjacent to the address field 102 is a buffer area 104 followed by a VAP area 142. Next a separation space 106 to provide space between the various fields on the media. A sync field 108 is then encountered, followed by a data field 144. As can be appreciated, the structure shown in FIGS. 5 & 6 is slightly more involved than the schematic illustration of FIGS. 2 & 3.

Referring now to FIG. 6, the end portion of the various data sectors 140 is illustrated. In this figure, the data field 144 is continued until an ECC data field 146 is reached. While the data field 144 is shown ending with ECC data field 146, other fields could also exist.

As mentioned above, FIGS. 5 & 6 illustrate several variations of data patterns stored on the media. Specifically, within the various parallel data sectors 140 shown in these two figures, two variations are shown in data fields 144. A first area 152 of data fields 144 shows an illustration of parallel shredded tracks. In first area 152, each particular data field for each parallel sector has the above referenced series of spaces written to this area. Alternatively, a second area 154 of data fields 144 shows alternate written and shredded tracks. In the shredded tracks 156, a series of spaces are again written across the entire data field in a predetermined manner. Alternatively, each non-shredded track 158 will have a series of marks written to the media surface representative of the data stored therein. Obviously, FIGS. 5 & 6 illustrates the very different appearance of these two areas (shredded area 152 and alternate tracks shredded area 154).

The advantages and features of the present invention, along with other advantages, will be understood by those skilled in the art. While various embodiments of the present invention have been described above in order to illustrate their features and operation, it is not intended that the present application be limited to these embodiments. It is clearly understood that certain modifications and alterations can be made without departing from the scope and spirit of the following claims.

What is claimed is:

1. A method for providing data security in a data storage system by shredding data no longer wanted, comprising:
identifying a selected data storage sector containing data that is to be shredded based upon a sector address;
identifying a data storage area of the sector, wherein the data storage sector contains encoded data;
overwriting the entire data field with a predetermined pattern, thus rendering the encoded data undecipherable; and
verifying that the overwritten storage area contains the predetermined pattern, while also verifying that information in remaining areas of the selected data storage sector remain unchanged.

2. The method of claim 1 wherein the predetermined pattern is a series of repeated spaces.

3. The method of claim 1 wherein the predetermined pattern is a series of repeated marks.

4. The method of claim 1 wherein the remaining areas of the selected data storage sector comprise a verify and protect section, and an error correction code section.

5. The method of claim 1 wherein the remaining area comprises an addressing section.

6. The method of claim 1 wherein the data storage system is an optical storage system and the selected data storage sector is stored on an optical media.

7. The method of claim 6 wherein the predetermined pattern is a series of repeated spaces which causes the information previously stored in the selected data sector to become indecipherable.

8. A method of shredding data previously stored on optical media by an optical data storage system, wherein the stored data is maintained in sectors with each sector including a verify and protect portion, a data storage portion and an error correction code portion, the method comprising:
identifying a selected sector on the optical media having data to be shredded, including the verify and protect portion, the data storage portion and the error correction code portion of the selected sector;
overwriting a data portion of the selected sector with a predetermined pattern without modifying the verify and protect portion and the error correction portion; and
verifying that the data portion has been overwriting with the predetermined pattern and any previous data is undecipherable.

9. The method of claim 8 wherein the predetermined pattern is a series of repeated spaces.

10. The method of claim 8 wherein the predetermined patter is a series of repeated marks.
